(19) United States
(12) Patent Application Publication
(10) Pub. No.: US 2025/0126605 A1
(43) Pub. Date: Apr. 17, 2025

(54) METHOD AND APPARATUS FOR EVALUATING TIME-FREQUENCY RESOURCE TO BE TRANSMITTED, RESOURCE SELECTION METHOD AND APPARATUS, AND DEVICE

(71) Applicant: Beijing Xiaomi Mobile Software Co., Ltd., Beijing (CN)

(72) Inventor: Qun ZHAO, Beijing (CN)

(21) Appl. No.: 18/578,608

(22) PCT Filed: Jul. 14, 2021
(86) PCT No.: PCT/CN2021/106353

§ 371 Date: Jan. 11, 2024

(51) Int. Cl. H04W 72/02; H04B 17/318; H04W 72/40

(52) U.S. Cl. CPC H04W 72/02; H04B 17/328; H04W 72/40

(57) ABSTRACT

A method for evaluating a time-frequency resource to be used for transmission, includes: performing, based on partial sensing, at least one of resource re-evaluation or resource preemption evaluation for the time-frequency resource in a first target time unit, wherein the first target time unit is different from a second target time unit, the first target time unit is earlier than the second target time unit, and the second target time unit is a time unit which is used when performing the at least one of resource re-evaluation or resource preemption evaluation for the time-frequency resource based on sensing.

### CROSS REFERENCE TO RELATED APPLICATION

The present application is a U.S. National Stage of International Application No. PCT/CN2021/106353, filed on Jul. 14, 2021, the content of which is incorporated herein by reference in its entirety.

### TECHNICAL FIELD

The present disclosure relates to the field of communication technologies, and in particular, to a method for evaluating a time-frequency resource to be used for transmission, a resource selection method, an apparatus and a device.

### BACKGROUND

Based on the sidelink, direct communication between terminals in the Vehicle to everything (V2X) system can be achieved. Before a terminal device performs sidelink transmission based on a selected time-frequency resource to be used for transmission, the terminal device needs to perform resource re-evaluation and/or resource preemption evaluation for the time-frequency resource to be used for transmission.

In order to reduce the energy consumption of a terminal device during resource selection, the terminal device can perform resource selection based on partial sensing. In resource selection based on partial sensing, the terminal device performs sensing only in part of time units, and accordingly selects a time-frequency resource to be used for transmission only in part of time units to perform transmission.

For a terminal device that performs resource selection based on partial sensing, compared to full sensing, the terminal device can only use one or more time-frequency resources within a specific time unit set to generate a candidate resource set. When performing pre-evaluation and/or preemption evaluation for a time-frequency resource to be used for transmission (the time-frequency resource is selected but transmission on the time-frequency resource is not performed), if the terminal device still uses only time-frequency resource(s) within the specific time unit set to generate a candidate resource set, a case where candidate resources are not sufficient may occur.

### SUMMARY

According to an aspect of the present disclosure, there is provided a method for evaluating a time-frequency resource to be used for transmission, including:
based on partial sensing, performing resource re-evaluation and/or resource preemption evaluation for the time-frequency resource to be used for transmission in a first target time unit;
wherein the first target time unit is different from a second target time unit, the first target time unit is earlier than the second target time unit, and the second target time unit is a time unit which is used when performing resource re-evaluation and/or resource preemption evaluation for the time-frequency resource to be used for transmission based on sensing.

According to another aspect of the present disclosure, there is provided a resource selection method, including:
in a procedure of resource re-evaluation and/or resource preemption evaluation, performing expansion of at least one candidate resource in a second candidate resource set, wherein the second candidate resource set is a candidate resource set after resource exclusion based on partial sensing.

According to an aspect of the present disclosure, there is provided resource selection method, including:
in a procedure of resource re-evaluation and/or resource preemption evaluation for a time-frequency resource to be used for transmission, in response to that the time-frequency resource to be used for transmission does not belong to a second candidate resource set, abandoning transmission on the time-frequency resource to be used for transmission, and not performing resource reselection for the time-frequency resource to be used for transmission, wherein the second candidate resource set is a candidate resource set after resource exclusion based on partial sensing.

According to an aspect of the present disclosure, there is provided an apparatus for evaluating a time-frequency resource to be used for transmission, including:
an execution module configured to, based on partial sensing, perform resource re-evaluation and/or resource preemption evaluation for the time-frequency resource to be used for transmission in a first target time unit;
wherein the first target time unit is different from a second target time unit, the first target time unit is earlier than the second target time unit, and the second target time unit is a time unit which is used when performing resource re-evaluation and/or resource preemption evaluation for the time-frequency resource to be used for transmission based on sensing.

According to another aspect of the present disclosure, there is provided a resource selection apparatus, including:
an expansion module configured to, in a procedure of resource re-evaluation and/or resource preemption evaluation, perform expansion of at least one candidate resource in a second candidate resource set, wherein the second candidate resource set is a candidate resource set after resource exclusion based on partial sensing.

According to another aspect of the present disclosure, there is provided a resource selection apparatus, including:
an execution module configured to, in a procedure of resource re-evaluation and/or resource preemption evaluation for a time-frequency resource to be used for transmission, in response to that the time-frequency resource to be used for transmission does not belong to a second candidate resource set, abandon transmission on the time-frequency resource to be used for transmission, and not perform resource reselection for the time-frequency resource to be used for transmission, wherein the second candidate resource set is a candidate resource set after resource exclusion based on partial sensing.

According to another aspect of the present disclosure, there is provided a terminal device including: a processor; and a transceiver connected to the processor;
wherein the processor is configured to: based on partial sensing, perform resource re-evaluation and/or resource preemption evaluation for the time-frequency resource to be used for transmission in a first target time unit;
wherein the first target time unit is different from a second target time unit, the first target time unit is earlier than the second target time unit, and the second target time unit is a time unit which is used when performing resource re-evaluation and/or resource preemption evaluation for the time-frequency resource to be used for transmission based on sensing.

According to another aspect of the present disclosure, there is provided a terminal device, including: a processor; and a transceiver connected to the processor;
wherein the processor is configured to: in a procedure of resource re-evaluation and/or resource preemption evaluation, perform expansion of at least one candidate resource in a second candidate resource set, wherein the second candidate resource set is a candidate resource set after resource exclusion based on partial sensing.

According to another aspect of the present disclosure, there is provided a terminal device, including: a processor; and a transceiver connected to the processor;
wherein the processor is configured to: in a procedure of resource re-evaluation and/or resource preemption evaluation for a time-frequency resource to be used for transmission, in response to that the time-frequency resource to be used for transmission does not belong to a second candidate resource set, abandon transmission on the time-frequency resource to be used for transmission, and not perform resource reselection for the time-frequency resource to be used for transmission, wherein the second candidate resource set is a candidate resource set after resource exclusion based on partial sensing.

According to another aspect of the present disclosure, there is provided a computer-readable storage medium, wherein executable instructions are stored in the readable storage medium, and the executable instructions are loadable and executable by a processor to implement the method for evaluating the time-frequency resource to be used for transmission as described in the above aspects or to implement the resource selection method as described in the above aspects.

According to another aspect of the present disclosure, there is provided a chip, including a programmable logic circuit and/or a program instruction. When the chip is run on a computer device, the method for evaluating the time-frequency resource to be used for transmission or the resource selection method as described in the above aspects is implemented.

According to another aspect of the present disclosure, there is provided a computer program product. When the computer program product is run on a processor of a computer device, the computer device is caused to perform the method for evaluating the time-frequency resource to be used for transmission or the resource selection method as described in the above aspects.

### BRIEF DESCRIPTION OF THE DRAWINGS

The accompanying drawings of the present disclosure will be described below. Obviously, the drawings in the following description are only some embodiments of the present disclosure. For those of ordinary skill in the art, other embodiments can also be obtained.

FIG. 1 is a schematic diagram of resource selection according to an example embodiment of the present disclosure;

FIG. 2 is a schematic diagram of resource re-evaluation and resource preemption evaluation according to an example embodiment of the present disclosure;

FIG. 3 is a schematic diagram of a communication system architecture according to an example embodiment of the present disclosure;

FIG. 4 is a flowchart of a method for evaluating a time-frequency resource to be used for transmission according to an example embodiment of the present disclosure;

FIG. 5 is a flowchart of a resource selection method according to an example embodiment of the present disclosure;

FIG. 6 is a flowchart of a resource selection method according to an example embodiment of the present disclosure;

FIG. 7 is a flowchart of a method for evaluating a time-frequency resource to be used for transmission according to an example embodiment of the present disclosure;

FIG. 8 is a schematic diagram of a first time window according to an example embodiment of the present disclosure;

FIG. 9 is a flowchart of a resource selection method according to an example embodiment of the present disclosure;

FIG. 10 is a flowchart of a resource selection method according to an example embodiment of the present disclosure;

FIG. 11 is a structural block diagram of an apparatus for evaluating a time-frequency resource to be used for transmission according to an example embodiment of the present disclosure;

FIG. 12 is a structural block diagram of a resource selection apparatus according to an example embodiment of the present disclosure;

FIG. 13 is a structural block diagram of a resource selection apparatus according to an example embodiment of the present disclosure;

FIG. 14 is a schematic structural diagram of a communication device according to an example embodiment of the present disclosure.

### DETAILED DESCRIPTION

In order to make purposes, technical solutions and advantages of the present disclosure clearer, the embodiments of the present disclosure will be further described in detail below with reference to the accompanying drawings.

Example embodiments will be described in detail herein, examples of which are illustrated in the accompanying drawings. When the following description refers to the drawings, the same numbers in different drawings refer to the same or similar elements unless otherwise indicated. The implementations described in the following example embodiments do not represent all implementations consistent with the present disclosure. Rather, they are merely examples of apparatuses and methods consistent with aspects of the present disclosure as set forth the appended claims.

The terminologies used in the present disclosure are for the purpose of describing example embodiments only and are not intended to be limiting of the present disclosure. As used in the present disclosure and the appended claims, a singular form “a/an”, “the” or “said” is intended to include a plural form as well, unless the context clearly dictates otherwise. It will also be understood that the term “and/or” as used herein refers to and includes any or all possible combinations of one or more associated listed items.

It should be understood that although the terms “first”, “second”, “third”, etc. may be used in the present disclosure to describe various information, the information should not be limited to these terms. These terms are only used to distinguish information of the same type from each other. For example, without departing from the scope of the present disclosure, first information may also be called second information, and similarly, second information may also be called first information. Depending on the context, the word “if” as used herein may be interpreted as “when” or “in a case where . . . ” or “in response to determining . . . ”.

Relevant content of Vehicle to everything (V2X) will be introduced first:

Internet of Vehicles communications include a Vehicle to Vehicle (V2V) communication, a Vehicle to Infrastructure (V2I) communication, and a Vehicle to People (V2P) communication. By supporting the V2V communication, V2I communication and V2P communication, the Internet of Vehicles can effectively improve traffic safety, improve traffic efficiency and enrich travel experience.

Using existing cellular communication technologies to support Internet of Vehicles communications can effectively utilize deployed base stations, reduce equipment overhead, and help provide services with Quality of Service (QOS) guarantee, thereby meeting the requirements of Internet of Vehicles services.

In Release 14 (R14)/R15 of Long Term Evolution (LTE), supporting Internet of Vehicles communications through a cellular network is realized. Specifically, this refers to Cellular based V2X (C-V2X) technology. In C-V2X, communications between a vehicle-mounted device (for example, a vehicle-mounted terminal) and other device(s) may be forwarded through a base station and a core network device, i.e., using a communication link (including an uplink (UL) communication and a downlink (DL) communication) between a terminal device and a base station in an existing cellular network to realize the communications between the vehicle-mounted device and other device(s). Alternatively, a vehicle-mounted device may communicate with other device(s) through a direct link (also called sidelink) between devices.

Sidelink communication is a device-to-device communication method with high spectrum efficiency and low transmission delay. The sidelink has two transmission modes. The first transmission mode is as follows: a network device configures a transmission resource (time-frequency resource) for a terminal device (a vehicle-mounted device), and the terminal device performs sidelink data transmission on the configured transmission resource. The second transmission mode is as follows: a network device allocates a resource pool to a terminal device, and the terminal device autonomously selects one or more transmission resources in the resource pool for sidelink data transmission. For example, the terminal device may select a transmission resource from the resource pool by sensing, or select a transmission resource from the resource pool by random selection. Compared with the Uu interface communication, the sidelink communication has the characteristics of short delay and low overhead, and is very suitable for direct communications between a vehicle-mounted device and other surrounding devices that are geographically close to the vehicle-mounted device.

With the developments of 5G mobile communication technologies, in R16 of the 3rd Generation Partnership Project (3GPP), it was proposed to use 5G New Radio (NR) technology to realize support for new Internet of Vehicles communication services and scenarios, such as support for Vehicles Platooning, Extended Sensors, Advanced Driving, and Remote Driving), etc. Generically speaking, 5G V2X sidelink can provide higher communication rate, shorter communication delay, and more reliable communication quality.

Then, resource selection and resource reselection are introduced:

In the second mode of sidelink as described above, a terminal device needs to select one or more time-frequency resources to be used for transmission from a resource pool, and then performs sidelink data transmission. When the terminal device currently has no selected time-frequency resource to be used for transmission, this is called resource selection. When time-frequency resource(s) to be used for transmission which are currently selected by the terminal device is (are) unavailable (for example, preempted by another device), the terminal device needs to perform resource reselection.

A terminal device may learn a resource reserved by another terminal device by sensing Physical Sidelink Control Channel (PSCCH) sent by another terminal device. When the terminal device performs resource selection, the terminal device will exclude the resource reserved by other terminal device(s) to avoid resource collision.

In a procedure of resource selection and resource reselection, the terminal device first determines an initial candidate resource set, and then performs resource exclusion for the initial candidate resource set to obtain a second candidate resource set, and selects one or more time-frequency resources to be used for transmission from the second candidate resource set.

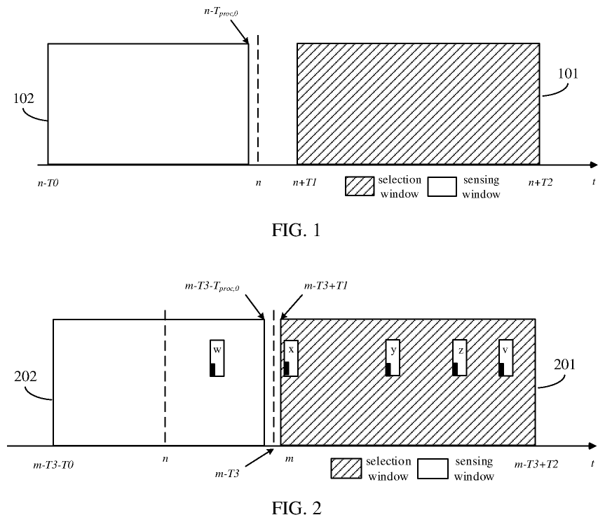

For example, FIG. 1 is a schematic diagram of resource selection according to an example embodiment of the present disclosure. As shown in FIG. 1, a data packet of a terminal device arrives in slot n, and the terminal device is triggered to perform resource selection. A resource selection window 101 starts from time n+T1 and ends at time n+T2, where 0≤T1ST_{proc,1}, T_{proc,1} is the time for the terminal device to perform resource selection and prepare data, and T2ₘᵢₙ≤T2≤Packet Delay Budget (PDB). The terminal device determines T2 min according to a priority of to-be-transmitted data of the terminal device itself. When T2 min is greater than the packet delay budget, T2=packet delay budget, to ensure that the terminal device can transmit the data packet before the maximum delay of the data packet is reached.

For example, a time unit or a target time unit or a first target time unit or a second target time unit mentioned in the embodiments of the present disclosure may refer to physical time, such as 1 μs (microsecond), 1 ms (millisecond), 1 symbol, 1 slot, 1 subframe, 1 frame. Alternatively, a time unit or a target time unit or a first target time unit or a second target time unit mentioned in the embodiments of the present disclosure may refer to logical time. For example, a set of all time domain resources that can be used for sideline communication is defined as a logical time set, or all time domain resources in a transmit (Tx) resource set are defined as a logical time set; and physical time is mapped into the logical time set.
Determine a candidate resource set:

The terminal device determines all available resources within the resource selection window as a second candidate resource set. If the terminal device transmits data in certain slots within a resource sensing window (resource sensing window 102 as shown in FIG. 1), the terminal device would not have performed sensing on these slots due to half-duplex constraint. Therefore, the terminal device needs to remove resources on slots in the resource selection window that correspond to these slots from the initial candidate resource set to avoid resource conflicts with other terminal devices. The terminal device can determine slots in the resource selection window that correspond to these slots using a value set of a resource reservation period field in the used resource pool configuration, and excludes all resources on the corresponding slots from the initial candidate resource set to obtain a second candidate resource set.

If PSCCH is sensed by the terminal device within the resource sensing window, the terminal device measures Reference Signal Received Power (RSRP) for the PSCCH or the RSRP for Physical Sidelink Shared Channel (PSSCH) scheduled by the PSCCH. If the measured RSRP is greater than a Sidelink RSRP (S-RSRP) threshold, and it is determined according to resource reservation information in sidelink control information transmitted in the PSCCH that its reserved resource(s) is (are) within the resource selection window, the terminal device excludes the reserved resource(s) from the initial candidate resource set to obtain a second candidate resource set. If the remaining resources in the second candidate resource set are less than X % of all resources in the second candidate resource set before resource exclusion, the terminal device raises the S-RSRP threshold by 3 dB and re-determines the candidate resource set.
Select one or more time-frequency resources to be used for transmission from the second candidate resource set:

After determining the second candidate resource set in the resource selection procedure, the terminal device selects a number of time-frequency resources to be used for transmission (for example, random selection) from the second candidate resource set as resources used by the terminal device for initial transmission and retransmission.

Afterwards, resource re-evaluation and resource preemption evaluation are introduced:

The current R16 sidelink supports resource re-evaluation and/or resource preemption evaluation mechanisms. When time-frequency resource(s) to be used for transmission evaluated by the terminal device (the time-frequency resources selected for sidelink transmission through the above method) are not reserved by other transmissions, this is called resource re-evaluation. When the time-frequency resource(s) to be used for transmission evaluated by the terminal device has (have) been reserved or preempted by other transmissions, this is called resource preemption evaluation.
Timing of resource re-evaluation and/or resource preemption evaluation:

Assuming that a time-frequency resource to be used for transmission is located in slot m, the terminal device performs resource re-evaluation and/or resource preemption evaluation at least in slot m−T3. Whether the terminal device performs resource re-evaluation and resource preemption evaluation in other slots depends on the terminal implementation and is not limited in a protocol.

Process for resource re-evaluation and/or resource preemption evaluation:
An initial candidate resource set is determined in the same manner as the terminal device performs resource selection and resource reselection, and then resource exclusion is performed on the initial candidate resource set to obtain a second candidate resource set for the resource re-evaluation and/or resource preemption evaluation procedure. It should be noted that the second candidate resource set in the resource selection procedure may be different from the second candidate resource set in the resource re-evaluation and/or resource preemption evaluation procedure.
If a time-frequency resource to be used for transmission for which re-evaluation is performed does not belong to the second candidate resource set in the resource re-evaluation and/or resource preemption evaluation procedure, the terminal device reselects a resource in the second candidate resource set to replace the time-frequency resource to be used for transmission for which re-evaluation is performed; or, if the time-frequency resource to be used for transmission for which the preemption evaluation is performed meets the following requirements, user equipment reselects a resource in the second candidate resource set to replace the time-frequency resource to be used for transmission for which preemption evaluation is performed.

The above requirements are as follows:

It is sensed by the terminal device that a resource reserved in direct connection control information (also called Sidelink Control Information, SCI) overlaps with the resource for which preemption evaluation is performed, and the measured value of the RSRP corresponding to the SCI is higher than the S-RSRP threshold, and priorities of to-be-transmitted data and data in the sensed SCI meets system configuration requirements.

For example, FIG. 2 is a schematic diagram of resource re-evaluation and resource preemption evaluation according to an example embodiment of the present disclosure. As shown in FIG. 2, resources w, x, y, z and v are time-frequency resources to be used for transmission that a terminal device has selected in slot n, and resource x is located in slot m. Before using resource x to perform transmission, the terminal device re-determines a candidate resource set through the above methods at least in time m−T3, i.e., the terminal determines a resource selection window 201 and a resource sensing window 202, performs resource exclusion on resources in the resource selection window 201 to determine a second candidate resource set. If the resource x is not in the second candidate resource set, resource reselection is triggered, and at this time, the terminal device may select a new transmission resource in the re-determined second candidate resource set, for example, any one of resources y, z and v, where T3 is equal to T_{proc,1}.

Afterwards, resource selection based on partial sensing is introduced:

Resource selection based on partial sensing is a resource selection method for power saving in 5G NR sidelink. In resource selection based on partial sensing, a terminal device performs sensing only in part of time units, and accordingly selects time-frequency resource(s) for transmission only in part of time units.

For a terminal device that performs resource selection based on partial sensing, as compared with full sensing (full sensing is described in the above described methods), only time-frequency resource(s) within a specific time unit set (determined based on the partial sensing mechanism) can be used to generate a second candidate resource set. When pre-evaluation and/or preemption evaluation is performed on a time-frequency resource to be used for transmission (the time-frequency resource is selected but transmission on the time-frequency resource is not performed), if the terminal device still uses only time-frequency resource(s) within the specific time unit set to generate the second candidate resource set, a case where candidate resources are not sufficient may occur. The case of insufficient candidate resources may cause the following consequences:
(1) According to a relevant mechanism, the S-RSRP threshold needs to be continuously raised to select suitable transmission resource(s). However, continuously raising the S-RSRP threshold may result in that transmissions that would cause severe interference are still performed.
(2) Even if resource reselection is started, suitable resources cannot be selected.

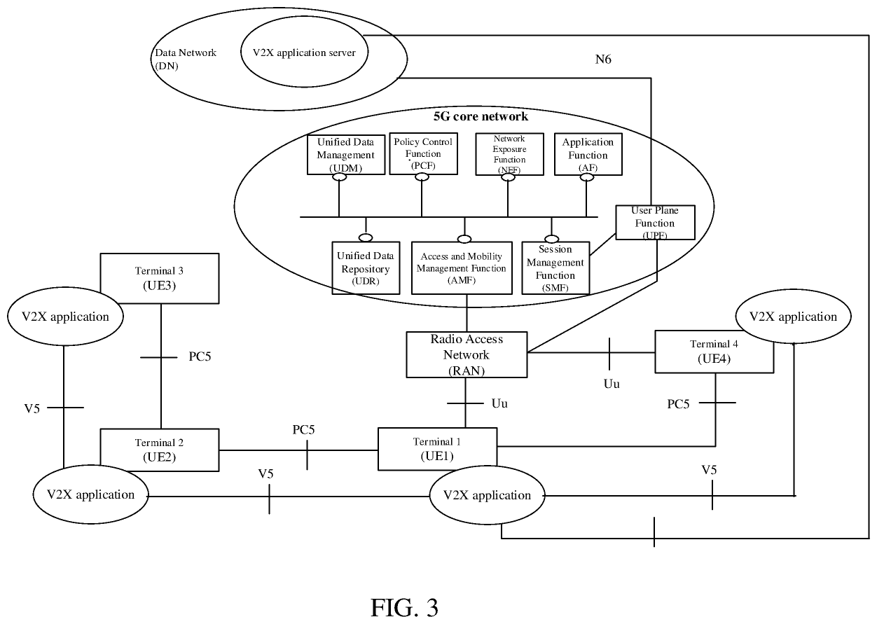

FIG. 3 is a schematic diagram of communication system architecture according to an example embodiment of the present disclosure. The communication system may be a schematic diagram of non-roaming 5G system architecture, which may be applied to Internet of Vehicles services using a Device to Device (D2D) technology.

The system architecture includes a data network (DN), which is equipped with a V2X application server required for V2X services. The system architecture further includes a 5G core network. The network functions of the 5G core network include: Unified Data Management (UDM), Policy Control Function (PCF), Network Exposure Function (NEF), Application Function (AF), Unified Data Repository (UDR), Access and Mobility Management Function (AMF), Session Management Function (SMF) and User Plane Function (UPF).

The system architecture further includes: a New Generation-Radio Access Network (NG-RAN) and four exemplarily shown terminals (i.e., terminal 1 to terminal 4). Optionally, each terminal is provided with a V2X application or an application that supports SL transmission. The radio access network is provided with one or more access network devices, such as base stations (gNB).

In the system architecture, the data network and the user plane function in the 5G core network are connected through a N6 reference point, the V2X application server and the V2X application in a terminal are connected through a V1 reference point: the radio access network is connected with the AMF function and the UPF function in the 5G core network, the radio access network is connected with the terminal 1 to terminal 5 through a Uu reference point; multiple terminals perform sidelink transmissions through a PC5 reference point, and multiple V2X applications are connected through a V5 reference point. The above reference points may also be called “interfaces”.

The “5G NR system” in the embodiments of the present disclosure may also be called a 5G system or an NR system, but those skilled in the art can understand its meaning. The technical solutions described in the embodiments of the present disclosure may be applied to the 5G NR system, or may be applied to subsequent evolution systems of the 5G NR system. The technical solutions described in the embodiments of the present disclosure may be applied to a V2X application, or may be applied to other applications that use sidelink transmission, such as public safety and commercial applications.

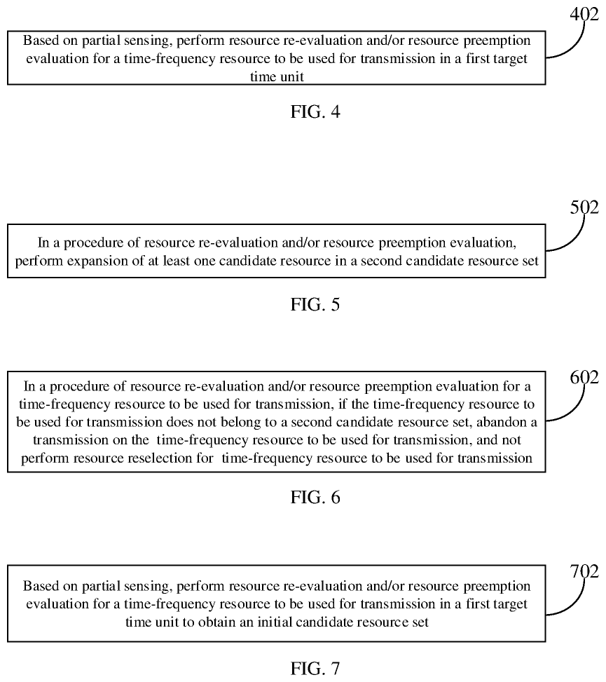

FIG. 4 shows a flowchart of a method for evaluating a time-frequency resource to be used for transmission according to an embodiment of the present disclosure. This method may be applied to the system architecture shown in FIG. 1. The method includes:

In step 402, based on partial sensing, resource re-evaluation and/or resource preemption evaluation is performed for a time-frequency resource to be used for transmission in a first target time unit.

The time-frequency resource to be used for transmission can be a resource that is selected based on a resource selection mechanism based on partial sensing. After the terminal device completes the selection of the time-frequency resource to be used for transmission but does not indicate the time-frequency resource to be used for transmission by transmitting sideline control information, the time-frequency resource to be used for transmission may still be reserved by another terminal device, which may result in resource collision. Therefore, it is necessary to perform resource re-evaluation and/or resource preemption evaluation on the time-frequency resource to be used for transmission. The time-frequency resource to be used for transmission is a time-frequency resource formed by a time resource and a frequency resource. For different resources, there are differences in time resources and frequency resources.

The first target time unit and the second target time unit are different, and the first target time unit is earlier than the second target time unit (the start time of the first target time unit is earlier than that of the second target time unit). The second target time unit is a time unit which is used when performing resource re-evaluation and/or resource preemption evaluation of the time-frequency resource to be used for transmission based on sensing (full sensing).

For example, a time unit in the embodiments of the present disclosure may be one of time units such as symbol, slot, subframe, etc.

For example, the first target time unit is [a1, b], and the second target time unit is [a2, b], where a1<a2. The number of candidate resources in [a1, b] is c1, and the number of candidate resources in [a2, b] is c2, then c1>c2. Because the existing partial sensing mechanism only selects a specific time unit in the second target time unit used by the full sensing mechanism to select candidate resources, when the first target time unit is earlier than the second target time unit, more candidate resources can be selected.

Optionally, the first target time unit is used to determine that the number of candidate resources in the initial candidate resource set is greater than a quantity threshold. That is, when the terminal device determines the initial candidate resource set based on the first target time unit, it can ensure that the number of available resources in the initial candidate resource set is greater than the quantity threshold. The initial candidate resource set is a candidate resource set before resource exclusion based on partial sensing. That is, the resources in the initial candidate resource set are resources determined within the first target time unit based on partial sensing.

Optionally, the initial candidate resource set includes candidate resources of at least Z time unit. The Z time units are the preset number of time units. Alternatively, the Z time units are the number of time units configured by a network device. Alternatively, the Z time units are preconfigured or predefined. For example, Z time units can be configured through Downlink Control Information (DCI) from a base station. That is, when the terminal device determines the initial candidate resource set based on the first target time unit, it can ensure that the number of initial candidate time units is not less than Z.

To sum up, in the method provided by the embodiment, resource re-evaluation and/or resource preemption evaluation is performed for the time-frequency resource to be used for transmission based on partial sensing in the first target time unit, the first target time unit is earlier than the second target time unit, the second target time unit is a time unit which is used when performing resource re-evaluation and/or resource preemption evaluation for the time-frequency resource to be used for transmission based on sensing. Therefore, it is possible to determine more candidate resources based on partial sensing and avoid the problem of insufficient candidate resources.

FIG. 5 shows a flowchart of a resource selection method according to an embodiment of the present disclosure. This method may be applied to the system architecture shown in FIG. 1. The method includes:

In step 502, in a procedure of resource re-evaluation and/or resource preemption evaluation, expansion of at least one candidate resource in a second candidate resource set is performed.

The second candidate resource set is a candidate resource set after resource exclusion based on partial sensing. That is, the terminal device can obtain the second candidate resource set after excluding unavailable resource(s) in the initial candidate resource set based on partial sensing. The second candidate resource set is the same as or different from the initial candidate resource set. The unavailable resource(s) includes (include) at least one resource reserved or used by device(s) other than the terminal device.

Optionally, the terminal device can realize expansion of the candidate resource(s) in the second candidate resource set by increasing the S-RSRP threshold (S-RSRP limit). At this time, in order to avoid a situation where raising the S-RSRP threshold results in that a transmission that may cause serious interference is still performed, the terminal device compares the increased S-RSRP threshold with the maximum threshold. Optionally, when the increased S-RSRP threshold is less than the maximum threshold, the terminal device can continue to increase the S-RSRP threshold. When the S-RSRP threshold after a certain increase is greater than the maximum threshold, the terminal device determines the second candidate resource set according to the maximum threshold and no longer increases the S-RSRP threshold.

Optionally, when the time-frequency resource to be used for transmission that is subject to resource re-evaluation and/or resource preemption evaluation does not belong to the second candidate resource set, that is, when the time-frequency resource to be used for transmission is an unavailable resource, the terminal device can still perform resource selection within a window [m+T1, m+T2], where m is the above-mentioned first target time unit or second target time unit, T1 is processing time of the terminal, and T2 is the data delay requirement of to-be-transmitted data. At this time, resources within the time window [m+T1, m+T2] are the second candidate resource set. Using the second candidate resource set for resource reselection can include resource(s) in time units that do not belong to the specific time unit set required for partial sensing-based resource selection into the available resource set.

For example, a time unit in the embodiments of the present disclosure may be one of time units such as symbol, slot, subframe, etc.

To sum up, in the method provided by the embodiments, the expansion of candidate resources in the second candidate resource set can be realized during the procedure of resource re-evaluation and/or resource preemption evaluation. Since the second candidate resource set is a candidate resource set after resource exclusion based on partial sensing, expansion of the candidate resources in the second candidate resource set, that is, expansion of the available resources for the terminal device to perform resource selection, can avoid the problem of insufficient candidate resources.

FIG. 6 shows a flowchart of a resource selection method according to an embodiment of the present disclosure. This method may be applied to the system architecture shown in FIG. 1. The method includes:

In step 602, in a procedure of resource re-evaluation and/or resource preemption evaluation for a time-frequency resource to be used for transmission, if the time-frequency resource to be used for transmission does not belong to a second candidate resource set, a transmission on the time-frequency resource to be used for transmission is abandoned, and resource reselection for the time-frequency resource to be used for transmission is not performed.

The time-frequency resource to be used for transmission may be a resource selected based on a resource selection mechanism based on partial sensing. After the terminal device completes the selection of the time-frequency resource to be used for transmission but does not indicate the time-frequency resource to be used for transmission by transmitting sideline control information, it is needed to perform resource re-evaluation and/or resource preemption evaluation for the time-frequency resource to be used for transmission.

The second candidate resource set is a candidate resource set after resource exclusion based on partial sensing. The time-frequency resource to be used for transmission does not belong to the second candidate resource set, that is, when the terminal device performs resource exclusion based on parting sensing in the procedure of resource re-evaluation and/or resource preemption evaluation for the time-frequency resource to be used for transmission, the terminal device determines the time-frequency resource to be used for transmission as an unavailable resource. The unavailable resource(s) includes (include) a resource reserved or used by device(s) other than the terminal device.

The terminal device abandons transmission on the time-frequency resource to be used for transmission and does not perform resource reselection for the time-frequency resource to be used for transmission. This can avoid resource selection when the set of available resources is too small, which may increase mutual interference and cause system performance degradation.

To sum up, in the method provided by the embodiments, the terminal device abandons the transmission on the time-frequency resource to be used for transmission and does not perform resource reselection for the time-frequency resource to be used for transmission in a case where the time-frequency resource to be used for transmission does not belong to the candidate resource set which is obtained after resource exclusion based on partial sensing. This can avoid resource selection when the set of available resources is too small, which may increase mutual interference and cause system performance degradation.

Optionally, the terminal device can solve the problem of insufficient candidate resources in two schemes.

Scheme 1: Perform resource re-evaluation and/or resource preemption evaluation in the first target time unit.

FIG. 7 shows a flowchart of a method for evaluating a time-frequency resource to be used for transmission according to an embodiment of the present disclosure. This method may be applied to the system architecture shown in FIG. 1. The method includes:

In step 702, based on partial sensing, resource re-evaluation and/or resource preemption evaluation for a time-frequency resource to be used for transmission is performed in a first target time unit to obtain an initial candidate resource set.

The first target time unit is a time unit which is used when performing resource re-evaluation and/or resource preemption evaluation for the time-frequency resource to be used for transmission based on partial sensing. The first target time unit is different from a second target time unit, and the first target time unit is earlier than the second target time unit. The second target time unit is a time unit which is used when performing resource re-evaluation and/or resource preemption evaluation for the time-frequency resource to be used for transmission based on sensing (full sensing).

For example, a time unit in the embodiments of the present disclosure may be one of time units such as symbol, slot, subframe, etc.

Optionally, the number of candidate resources in the initial candidate resource set is greater than a quantity threshold. The first target time unit is used to determine that the number of candidate resources in the initial candidate resource set is greater than the quantity threshold. That is, when the terminal device performs resource re-evaluation and/or resource preemption evaluation for the time-frequency resource to be used for transmission based on the first target time unit to determine the initial candidate resource set, it can ensure that the number of available resources in the initial candidate resource set is greater than the quantity threshold. The initial candidate resource set is a candidate resource set before resource exclusion based on partial sensing. That is, the resources in the initial candidate resource set are resources determined within the first target time unit based on partial sensing.

Optionally, the terminal device uses the first target time unit at timing being earlier than the first one of Y time units. The Y time units are time units belonging to a specific time unit set. The specific time unit set is a time unit set which is obtained based on mapping of a target time unit set. The target time unit set is an initial candidate time unit set which is determined when selecting the time-frequency resource to be used for transmission based on partial sensing.

Optionally, the above mapping includes:
(1) If the time-frequency resource to be used for transmission (a resource for which resource re-evaluation and/or resource preemption evaluation is required) is selected through aperiodic resource selection, or the time-frequency resource to be used for transmission is selected through periodic resource selection and is within the first period, the specific time unit set in this case is the target time unit set;
(2) If the time-frequency resource to be used for transmission is selected through periodic resource selection and is within a k-th period, the specific time unit set is obtained by delaying the target time unit set by (k−1) T, where k is a positive integer and T is the period.

Optionally, the first target time unit is used to determine that the initial candidate resource set includes candidate resources of at least Z time units.

Optionally, the number of candidate resources in the Z time units is greater than the quantity threshold.

Optionally, the Z time units are the preset number of time units. Alternatively, the Z time units are the number of time units configured by a network device. Alternatively, the Z time units are preconfigured or predefined. For example, the Z time units can be configured through DCI sent by a base station.

Optionally, in a case where resource re-evaluation and/or resource preemption evaluation only selects an initial candidate resource set within a specific time unit set, the terminal device ensures that the number of time units belonging to the specific time unit set within the first time window [A+T3, A+T4] is not less than Z time units. That is, in a case of resource selection mechanism based on partial sensing, the terminal device ensures that the number of time units in the specific time unit set used for partial sensing is not less than Z time units when performing resource re-evaluation and/or resource preemption evaluation.

A is the above-mentioned first target time unit, T3 is the processing time of the terminal (the time for the terminal device to perform resource selection and prepare data), and T4 is the packet delay budget (PDB) of the to-be-transmitted data.

The specific time unit set is a time unit set which is obtained based on mapping of a target time unit set. The target time unit set is an initial candidate time unit set which is determined when selecting the time-frequency resource to be used for transmission based on partial sensing. That is, the specific time unit set is determined based on the time unit set which is determined when selecting the time-frequency resource to be used for transmission based on partial sensing.

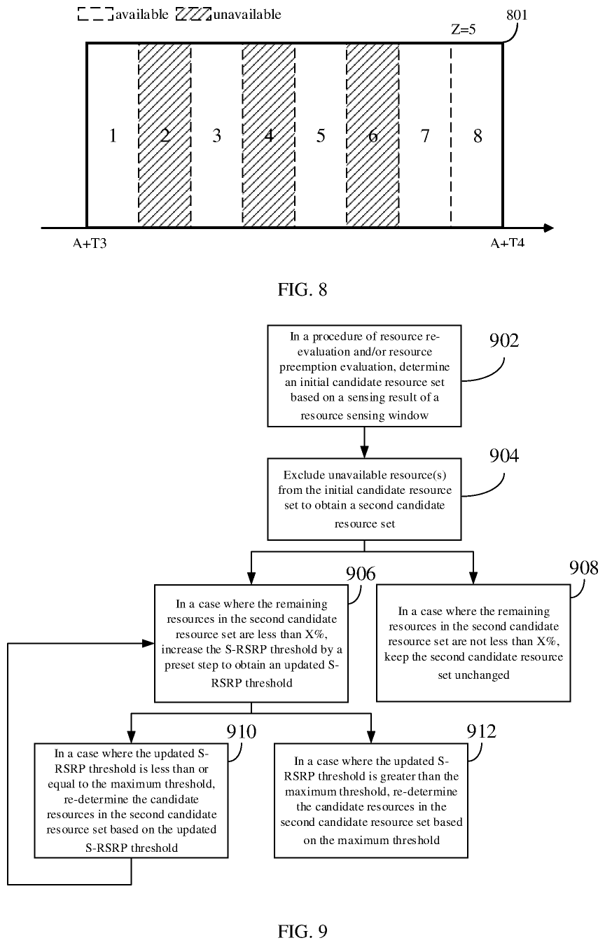

For example, FIG. 8 is a schematic diagram of a first time window according to an example embodiment of the present disclosure. As shown in FIG. 8, Z=5, the terminal device ensures that the number of time units in the first time window 801 which belong to the specific time unit set is not less than 5 time units. The first time window 801 determined by the terminal device includes 8 time units. Due to the restriction of partial sensing, the terminal device can only select candidate resources in time unit 1, time unit 3, time unit 5, time unit 7 and time unit 8, and the number of time units belonging to the specific time unit set is 5.

Optionally, according to the magnitude relationship between Z and Y, the terminal device can use the first target time unit at different timing to determine the initial candidate resource set:
(1) In a case of Z=Y, when the terminal device uses the above-mentioned first target time unit, the terminal device uses the first target time unit at the timing being earlier the first time unit among the Y time units;
(2) in a case of Z<Y, when the terminal device uses the above-mentioned first target time unit, the terminal device uses the first target time unit at the timing being earlier than the (Y−Z+1)-th time unit in the specific time unit set;
where the Y time units are time units belonging to the specific time unit set. The Y time units are time units selected during the resource selection procedure. Alternatively, the Y time units are time units in which the time-frequency resource to be used for transmissions which are selected during the resource selection procedure are located.

The specific time unit set is a time unit set which is obtained based on mapping of a target time unit set. The target time unit set is an initial candidate time unit set which is determined when selecting the time-frequency resource(s) to be used for transmission based on partial sensing.

To sum up, in the method provided by the embodiments, resource re-evaluation and/or resource preemption evaluation for time-frequency resource(s) to be used for transmission based on partial sensing is performed in the first target time unit, which can ensure that the number of candidate resources in the initial candidate resource set is greater than the quantity threshold, so as to avoid the problem of insufficient candidate resources.

Scheme 2: Expansion of candidate resource(s) in a second candidate resource set.

Change the way in which the second candidate resource set is generated during pre-evaluation and/or preemption evaluation.

FIG. 9 shows a flowchart of a resource selection method according to an embodiment of the present disclosure. This method may be applied to the system architecture shown in FIG. 1. The method includes:

In step 902, in a procedure of resource re-evaluation and/or resource preemption evaluation, an initial candidate resource set is determined based on a sensing result of a resource sensing window.

The initial candidate resource set is a candidate resource set after resource exclusion based on partial sensing. The resource sensing window is a sensing window which is used to determine the initial candidate resource set in the resource selection mechanism based on partial sensing.

In step 904, unavailable resource(s) is (are) excluded from the initial candidate resource set to obtain a second candidate resource set.

The unavailable resource(s) includes (include) resource(s) reserved or used by device(s) other than terminal device. An unavailable resource is a resource which is indicated by SCI and whose S-RSRP measurement value exceeds the S-RSRP threshold. An unavailable resource being indicated by SCI includes that the resource is indicated by SCI as being reserved by another terminal device or being used by another terminal device.

After obtaining the second candidate resource set, the terminal device determines whether to update the S-RSRP threshold based on whether the remaining resources in the second candidate resource set are less than X %.

In step 906, in a case where the remaining resources in the second candidate resource set are less than X %, the S-RSRP threshold is increased by a preset step to obtain an updated S-RSRP threshold.

The remaining resources in the second candidate resource set being less than X % refers to that the ratio of resources in the second candidate resource set to resources in the initial candidate resource set is less than X %. Optionally, the preset step is 3 db. The initial S-RSRP threshold and X value can be indicated by the DCI sent by the base station, or can be preconfigured in the terminal device.

In step 908, in a case where the remaining resources in the second candidate resource set are not less than X %, the second candidate resource set is kept unchanged.

After updating the S-RSRP threshold, the terminal device re-determines the candidate resources in the second candidate resource set based on the relationship between the updated S-RSRP threshold and the maximum threshold.

In step 910, in a case where the updated S-RSRP threshold is less than or equal to the maximum threshold, the candidate resources in the second candidate resource set are re-determined based on the updated S-RSRP threshold.

In step 912, in a case where the updated S-RSRP threshold is greater than the maximum threshold, the candidate resources in the second candidate resource set are re-determined based on the maximum threshold.

In a case where the remaining resources in the second candidate resource set are less than X %, the terminal device compares the updated S-RSRP threshold (S-RSRP threshold) with the maximum threshold (S-RSRP_MAX). If the updated S-RSRP threshold is less than the maximum threshold, the terminal device increases the S-RSRP threshold by a preset step to expand the second candidate resource set.

If the updated S-RSRP threshold is greater than the maximum threshold, the terminal device uses the maximum threshold to re-determine the candidate resources in the second candidate resource set to expand the second candidate resource set. At this time, the terminal device no longer increases the S-RSRP threshold by the preset step, that is, the terminal device no longer updates the S-RSRP threshold.

Optionally, after re-determining the second candidate resource set, the terminal device uses randomly selected resource(s) within the second candidate resource set as reselected resources for the time-frequency resource(s) to be used for transmission (resource(s) subject to resource re-evaluation and/or resource preemption evaluation).

To sum up, in the method provided in the embodiments, the second candidate resource set is expanded by increasing the S-RSRP threshold by a preset step, thereby avoiding the problem of insufficient candidate resources. In addition, by setting the maximum threshold, the technical solutions in the embodiments can avoid a situation where raising of the S-RSRP threshold causes resources that are not suitable for sidelink transmission to be divided into the second candidate resource set.

Change the processing method when a time-frequency resource to be used for transmission for which pre-evaluation and/or preemption evaluation is performed does not belong to a second candidate resource set.

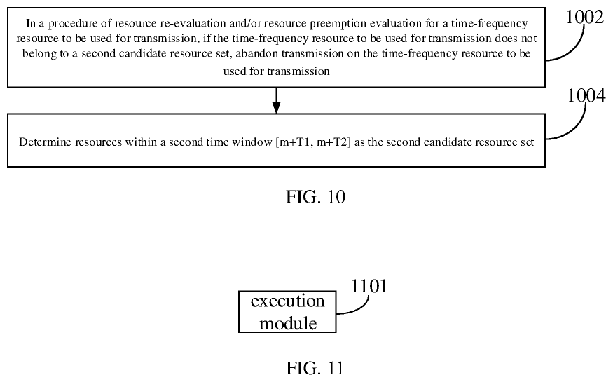

FIG. 10 shows a flowchart of a resource selection method according to an embodiment of the present disclosure. This method can be applied to the system architecture shown in FIG. 1. The method includes:

In step 1002, in a procedure of resource re-evaluation and/or resource preemption evaluation for a time-frequency resource to be used for transmission, if the time-frequency resource to be used for transmission does not belong to a second candidate resource set, transmission on the time-frequency resource to be used for transmission is abandoned.

The time-frequency resource to be used for transmission is a resource which is selected by a terminal device and is to be used for transmission. Before using the time-frequency resource to be used for transmission, the terminal device performs re-evaluation and/or resource preemption evaluation for the time-frequency resource to be used for transmission.

The time-frequency resource to be used for transmission not belonging to the second candidate resource set refers to that the time-frequency resource to be used for transmission is an unavailable resource. Specifically, the time-frequency resource to be used for transmission is reserved by another terminal device or is used by another terminal device.

The terminal device abandons transmission on the time-frequency resource to be used for transmission, that is, the terminal device does not use the time-frequency resource to be used for transmission to perform transmission.

In step 1004, resources within a second time window [m+T1, m+T2] are determined as the second candidate resource set;
where m is the above-mentioned first target time unit, T1 is the processing time of the terminal, and T2 is the data delay requirement of the to-be-transmitted data. The resources within the second time window [m+T1, m+T2] are the second candidate resource set. Optionally, lengths of the second time window and the first time window may be the same or different.

Using the second candidate resource set to perform resource reselection can include resources in time units that do not belong to the specific time unit set required for partial sensing-based resource selection into the available resource set.

Optionally, the terminal device determines randomly selected resources in the second candidate resource set as reselected resources for time-frequency resources to be used for transmission (resources for which resource re-evaluation and/or resource preemption evaluation is performed).

Optionally, during the resource re-evaluation and/or resource preemption evaluation procedure for a time-frequency resource to be used for transmission, if the time-frequency resource to be used for transmission does not belong to the second candidate resource set, the terminal device can also abandon transmission on the time-frequency resource to be used for transmission, and does not perform resource reselection for the time-frequency resources to be used for transmission. This can avoid resource selection when the available resource set is too small, which may increase mutual interference and cause system performance degradation.

Optionally, when the priority of the to-be-transmitted data is lower than the priority threshold, the terminal device may perform expansion of the candidate resources in the second candidate resource set during the procedure of resource re-evaluation and/or resource preemption evaluation, thereby enabling the terminal device to obtain better energy-saving gain. When the priority of the to-be-transmitted data is higher than the priority threshold, the terminal device does not process the second candidate resource set, and when the time-frequency resource to be used for transmission is unavailable, the terminal device reselects a resource from the second candidate resource set to ensure transmission reliability.

Alternatively, when the number of candidate time units is less than the time unit threshold, the terminal device may perform expansion of candidate resources in the second candidate resource set during the procedure of resource re-evaluation and/or resource preemption evaluation. When the number of candidate time units is not less than the time unit threshold, the terminal device does not process the second candidate resource set, and when the time-frequency resource to be used for transmission is unavailable, the terminal device reselects a resource from the second candidate resource set. Optionally, the above time unit threshold can be indicated by a DCI sent by the base station, or preconfigured in the terminal device.

To sum up, according to the methods provided by the embodiments, when a time-frequency resource to be used for transmission does not belong to the second candidate resource set, the terminal device determines resources in the second time window as the second candidate resource set. This technical solution can include resources in time units that do not belong to the specific time unit set required by partial sensing-based resource selection into the available resource set. Thus, the second candidate resource set is expanded and the problem of insufficient candidate resources is avoided.

FIG. 11 is a structural block diagram of an apparatus for evaluating a time-frequency resource to be used for transmission according to an example embodiment of the present disclosure. The apparatus may be implemented as a terminal device, or may be implemented as a part of the terminal device. The apparatus includes an execution module 1101.

The execution module 1101 is configured to, based on partial sensing, perform resource re-evaluation and/or resource preemption evaluation for the time-frequency resource to be used for transmission in a first target time unit.

The first target time unit is different from a second target time unit, the first target time unit is earlier than the second target time unit, and the second target time unit is a time unit which is used when performing resource re-evaluation and/or resource preemption evaluation for the time-frequency resource to be used for transmission based on sensing.

In an optional design, the execution module 1101 is configured to:
perform resource re-evaluation and/or resource preemption evaluation in the first target time unit to obtain an initial candidate resource set.

The initial candidate resource set is a candidate resource set before resource exclusion based on partial sensing.

In an optional design, the execution module 1101 is configured to:
the first target time unit be earlier than the first time unit of Y time units;
wherein the Y time units are time units belonging to a specific time unit set, the specific time unit set is a time unit set obtained based on mapping of a target time unit set, and the target time unit set is an initial candidate time unit set which is determined when performing selection of the time-frequency resource to be used for transmission based on partial sensing.

In an optional design, the initial candidate resource set includes a candidate resource of at least Z time units.

In an optional design, the Z time units are a preset number of time units;
or,
the Z time units are number of time units configured by a network device;
or,
the Z time units are preconfigured or predefined.

In an optional design, the execution module 1101 is configured to:
in a case where the resource re-evaluation and/or resource preemption evaluation selects the initial candidate resource set only in a specific time unit set, ensure that the number of time units belonging to the specific time unit within a first time window [A+T3, A+T4] is not less than the Z time units;
wherein A is the first target time unit, T3 is processing time of a terminal, T4 is packet delay budge of to-be-transmitted data, the specific time unit set is a time unit set obtained based on mapping of a target time unit set, and the target time unit set is an initial candidate time unit set which is determined when performing selection of the time-frequency resource to be used for transmission based on partial sensing.

In an optional design, the execution module 1101 is configured to:
in a case where Z is less than Y, the first target time unit be earlier than a (Y-Z+1)-th time unit in a specific time unit set;
wherein Y time units are time units belonging to the specific time unit set, the specific time unit set is a time unit set obtained based on mapping of a target time unit set, and the target time unit set is an initial candidate time unit set which is determined when performing selection of the time-frequency resource to be used for transmission based on partial sensing.

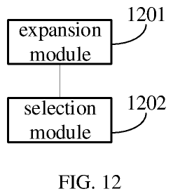

FIG. 12 is a structural block diagram of a resource selection apparatus according to an example embodiment of the present disclosure. The apparatus may be implemented as a terminal device, or may be implemented as a part of the terminal device. The apparatus includes an expansion module 1201.

The expansion module 1201 is configured to, in a procedure of resource re-evaluation and/or resource preemption evaluation, perform expansion of at least one candidate resource in a second candidate resource set, wherein the second candidate resource set is a candidate resource set after resource exclusion based on partial sensing.

In an optional design, the expansion module 1201 is configured to:
in the procedure of resource re-evaluation and/or resource preemption evaluation, determine an initial candidate resource set based on a sensing result of a resource sensing window;
exclude an unavailable resource in the initial candidate resource set to obtain the second candidate resource set, wherein the unavailable resource is a resource which is indicated by Sidelink Control Information (SCI) and a Sidelink Reference Signal Received Power (S-RSRP) measurement value for which exceeds a S-RSRP threshold;
in a case where remaining resources in the second candidate resource set are less than X %, increase the S-RSRP threshold by a preset step to obtain an updated S-RSRP threshold; and in a case where the updated S-RSRP threshold is greater than a maximum threshold, re-determine at least one candidate resource in the second candidate resource set according to the maximum threshold.

In an optional design, the expansion module 1201 is configured to:
in a procedure of resource re-evaluation and/or resource preemption evaluation for a time-frequency resource to be used for transmission, in response to that the time-frequency resource to be used for transmission does not belong to the second candidate resource set, abandon transmission on the time-frequency resource to be used for transmission; and
determine at least one resource within a second time window [m+T1, m+T2] as the second candidate resource set;
wherein m is a first target time unit, T1 is processing time of a terminal, and T2 is a data delay requirement of to-be-transmitted data.

In an optional design, the apparatus further includes:
a selection module 1202 configured to determine a randomly selected resource in the second candidate resource set as a reselected resource for the time-frequency resource to be used for transmission.

In an optional design, the expansion module 1201 is configured to:
in a case where a priority of to-be-transmitted data is higher than a priority threshold, perform expansion of the at least one candidate resource in the second candidate resource set in the procedure of resource re-evaluation and/or resource preemption evaluation.

In an optional design, the expansion module 1201 is configured to:
in a case where the number of candidate time units is less than a time unit threshold, perform expansion of the at least one candidate resource in the second candidate resource set in the procedure of resource re-evaluation and/or resource preemption evaluation.

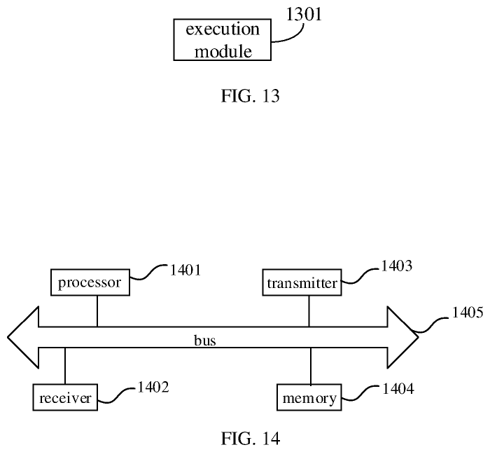

FIG. 13 is a structural block diagram of a resource selection apparatus according to an example embodiment of the present disclosure. The apparatus may be implemented as a terminal device, or may be implemented as a part of the terminal device. The apparatus includes an execution module 1301.

The execution module 1301 is configured to, in a procedure of resource re-evaluation and/or resource preemption evaluation for a time-frequency resource to be used for transmission, in response to that the time-frequency resource to be used for transmission does not belong to a second candidate resource set, abandon transmission on the time-frequency resource to be used for transmission, and not perform resource reselection for the time-frequency resource to be used for transmission, wherein the second candidate resource set is a candidate resource set after resource exclusion based on partial sensing.

FIG. 14 is a schematic structural diagram of a communication device according to an example embodiment of the present disclosure. The communication device includes: a processor 1401, a receiver 1402, a transmitter 1403, a memory 1404 and a bus 1405.

The processor 1401 includes one or more processing cores. The processor 1401 implements various functional applications and information processing by running software programs and modules.

The receiver 1402 and the transmitter 1403 may be implemented as a communication component, and the communication component may be a communication chip. The memory 1404 is connected to the processor 1401 through the bus 1405.

The memory 1404 may be configured to store at least one instruction, and the processor 1401 is configured to execute the at least one instruction to implement steps in the above method embodiments.

Additionally, memory 1404 may be implemented by any type of volatile or non-volatile storage device or combination thereof, including but not limited to: magnetic or optical disk, Electrically-Erasable Programmable Read Only Memory (EEPROM), Erasable Programmable Read Only Memory (EPROM), Static Random Access Memory (SRAM), Read-Only Memory (ROM), magnetic memory, flash memory, or Programmable Read-Only Memory (PROM).

When the communication device is implemented as a terminal device, the processor and the transceiver in the communication device involved in the embodiments of the present disclosure may perform the steps performed by the terminal device in any of the methods shown above, which will not be described again here.

In a possible implementation, when the communication device is implemented as a terminal device:
the processor is configured to, based on partial sensing, perform resource re-evaluation and/or resource preemption evaluation for the time-frequency resource to be used for transmission in a first target time unit;
wherein the first target time unit is different from a second target time unit, the first target time unit is earlier than the second target time unit, and the second target time unit is a time unit which is used when performing resource re-evaluation and/or resource preemption evaluation for the time-frequency resource to be used for transmission based on sensing.

In a possible implementation, when the communication device is implemented as a terminal device:
The processor is configured to, in a procedure of resource re-evaluation and/or resource preemption evaluation, perform expansion of at least one candidate resource in a second candidate resource set, wherein the second candidate resource set is a candidate resource set after resource exclusion based on partial sensing.

In a possible implementation, when the communication device is implemented as a terminal device:
the processor is configured to, in a procedure of resource re-evaluation and/or resource preemption evaluation for a time-frequency resource to be used for transmission, in response to that the time-frequency resource to be used for transmission does not belong to a second candidate resource set, abandon transmission on the time-frequency resource to be used for transmission, and not perform resource reselection for the time-frequency resource to be used for transmission, wherein the second candidate resource set is a candidate resource set after resource exclusion based on partial sensing.

In an example embodiment, a computer-readable storage medium is further provided. At least one instruction, at least one program, a code set or an instruction set is stored in the computer-readable storage medium, and the at least one instruction, at least one program, the code set or the instruction set is loadable and executable by a processor to implement the method for evaluating a time-frequency resource to be used for transmission or the resource selection method which is performed by the communication device according to the above method embodiments.

In an example embodiment, a chip is further provided. The chip includes a programmable logic circuit and/or a program instruction. When the chip is run on a computer device, the computer device is caused to implement the method for evaluating a time-frequency resource to be used for transmission or the resource selection method described in the above embodiments.

In an example embodiment, a computer program product is further provided.

When the computer program product is run on a processor of a computer device, the computer device is caused to perform the method for evaluating a time-frequency resource to be used for transmission or the resource selection method described in the above embodiments.

Those of ordinary skill in the art can understand that all or part of steps to implement the above embodiments may be implemented by hardware, or may be implemented by instructing relevant hardware through a program. The program may be stored in a computer-readable storage medium. The above-mentioned storage medium may be read-only memory, magnetic disk or optical disk, etc.

The above are only example embodiments of the present disclosure and are not intended to limit the present disclosure. Any modifications, equivalent substitutions, improvements, and so on made within the spirit and principles of the present disclosure fall within the protection scope of the present disclosure.

1. A method for evaluating a time-frequency resource to be used for transmission, comprising:
performing, based on partial sensing, at least one of resource re-evaluation or resource preemption evaluation for the time-frequency resource in a first target time unit;
wherein the first target time unit is different from a second target time unit, the first target time unit is earlier than the second target time unit, and the second target time unit is a time unit which is used when performing the at least one of resource re-evaluation or resource preemption evaluation for the time-frequency resource based on sensing.

2. The method according to claim 1, wherein performing the at least one of resource re-evaluation or resource preemption evaluation for the time-frequency resource in the first target time unit comprises:
performing the at least one of resource re-evaluation or resource preemption evaluation in the first target time unit to obtain an initial candidate resource set;
wherein the initial candidate resource set is a candidate resource set before resource exclusion based on partial sensing.

3. The method according to claim 2,
wherein the first target time unit is earlier than the first time unit of Y time units;
wherein the Y time units are time units belonging to a specific time unit set, the specific time unit set is a time unit set obtained based on mapping of a target time unit set, and the target time unit set is an initial candidate time unit set which is determined when performing selection of the time-frequency resource based on partial sensing.

4. The method according to claim 2, wherein the initial candidate resource set comprises a candidate resource of at least Z time units.

5. The method according to claim 4, wherein the Z time units are one of:
a preset number of time units;
a number of time units configured by a network device; or
being preconfigured or predefined.

6. The method according to claim 4, further comprising:
in response to that the at least one of resource re-evaluation or resource preemption evaluation selects the initial candidate resource set only in a specific time unit set, ensuring that the number of time units belonging to the specific time unit within a first time window [A+T3, A+T4] is not less than the Z time units;
wherein A is the first target time unit, T3 is processing time of a terminal, T4 is packet delay budge of to-be-transmitted data, the specific time unit set is a time unit set obtained based on mapping of a target time unit set, and the target time unit set is an initial candidate time unit set which is determined when performing selection of the time-frequency resource based on partial sensing.

7. The method according to claim 4,
wherein in response to that Z is less than Y, the first target time unit is earlier than a (Y−Z+1)-th time unit in a specific time unit set;
wherein Y time units are time units belonging to the specific time unit set, the specific time unit set is a time unit set obtained based on mapping of a target time unit set, and the target time unit set is an initial candidate time unit set which is determined when performing selection of the time-frequency resource based on partial sensing.

8. A resource selection method, comprising:
in a procedure of at least one of resource re-evaluation or resource preemption evaluation, performing expansion of at least one candidate resource in a candidate resource set, wherein the candidate resource set is a candidate resource set after resource exclusion based on partial sensing.

9. The method according to claim 8, wherein the candidate resource set is a second candidate resource set, and performing expansion of the at least one candidate resource in the second candidate resource set comprises:
determining an initial candidate resource set based on a sensing result of a resource sensing window;
excluding an unavailable resource in the initial candidate resource set to obtain the second candidate resource set, wherein the unavailable resource is a resource which is indicated by Sidelink Control Information (SCI) and a Sidelink Reference Signal Received Power (S-RSRP) measurement value for which exceeds a S-RSRP threshold;
in response to that remaining resources in the second candidate resource set are less than X %, increasing the S-RSRP threshold by a preset step to obtain an updated S-RSRP threshold; and
in response to that the updated S-RSRP threshold is greater than a maximum threshold, re-determining at least one candidate resource in the second candidate resource set according to the maximum threshold.

10. The method according to claim 8, wherein performing expansion of the at least one candidate resource in the candidate resource set comprises:
in response to that the time-frequency resource does not belong to the candidate resource set, abandoning transmission on the time-frequency resource; and
determining at least one resource within a second time window [m+T1, m+T2] as the candidate resource set;
wherein m is a first target time unit, T1 is processing time of a terminal, and T2 is a data delay requirement of to-be-transmitted data.

11. The method according to claim 8, further comprising:
determining a randomly selected resource in the candidate resource set as a reselected resource for the time-frequency resource to be used for transmission.

12. The method according to claim 8, further comprising:
in response to that a priority of to-be-transmitted data is higher than a priority threshold, performing expansion of the at least one candidate resource in the candidate resource set in the procedure of the at least one of resource re-evaluation or resource preemption evaluation.

13. The method according to claim 8, further comprising:
in response to that the number of candidate time units is less than a time unit threshold, performing expansion of the at least one candidate resource in the candidate resource set in the procedure of the at least one of resource re-evaluation or resource preemption evaluation.

14. (canceled)

15. A terminal device, comprising:
a processor; and
a memory configured to store an instruction executable by the processor;
wherein the processor is configured to:
perform, based on partial sensing, at least one of resource re-evaluation or resource preemption evaluation for a time-frequency resource to be used for transmission in a first target time unit;
wherein the first target time unit is different from a second target time unit, the first target time unit is earlier than the second target time unit, and the second target time unit is a time unit which is used when performing the at least one of resource re-evaluation or resource preemption evaluation for the time-frequency resource based on sensing.

16. The terminal device according to claim 15, wherein the processor is further configured to:
perform the at least one of resource re-evaluation or resource preemption evaluation in the first target time unit to obtain an initial candidate resource set;
wherein the initial candidate resource set is a candidate resource set before resource exclusion based on partial sensing.

17. The terminal device according to claim 16, wherein:
the first target time unit is earlier than the first time unit of Y time units;
wherein the Y time units are time units belonging to a specific time unit set, the specific time unit set is a time unit set obtained based on mapping of a target time unit set, and the target time unit set is an initial candidate time unit set which is determined when performing selection of the time-frequency resource based on partial sensing.

18.-21. (canceled)

22. A terminal device, comprising:
a processor; and
a memory configured to store an instruction executable by the processor;
wherein the processor is configured to perform the method according to claim 8.

23.-31. (canceled)

32. A non-transitory computer-readable storage medium having stored thereon instructions that, when executed by a processor, cause the processor to perform the method according to claim 1.

33. (canceled)

34. A non-transitory computer-readable storage medium having stored thereon instructions that, when executed by a processor, cause the processor to perform the method according to claim 8.
